(19) United States
(12) Patent Application Publication
(10) Pub. No.: US 2022/0403165 A1
(43) Pub. Date: Dec. 22, 2022

(54) A ONE-COMPONENT TYPE POLYURETHANE PREPOLYMER COMPOSITION

(71) Applicant: Dow Global Technologies LLC, Midland, MI (US)

(72) Inventors: Cheng Shen, Shanghai (CN); Nan Wang, Shanghai (CN); Gang Sun, Shanghai (CN); Masayuki Suzuki, Yokohama (JP); Jiawen Xiong, Shanghai (CN); Wei Li, Shanghai (CN)

(21) Appl. No.: 17/597,709

(22) PCT Filed: Aug. 6, 2019
(86) PCT No.: PCT/CN2019/099388

§ 371 Date: Jan. 19, 2022

(51) Int. Cl. C08L 75/08; C08G 18/12; C08G 18/48

(52) U.S. Cl. CPC C08L 75/08; C08G 18/12; C08G 18/4812; C08G 18/4841; C08G 18/4854; C08G 2150/00

(57) ABSTRACT

A one-component type polyurethane prepolymer composition comprises a reaction product formed through a reaction between reactants comprising (a) at least one polyisocyanate, and (b) a polyol blend comprising at least one bifunctional polyether polyol, wherein the bifunctional polyether polyol is a homopolymer of propylene oxide, homopolymer of butylene oxide, or copolymer of alkylene oxide, and has a number average molecular weight from 3000 g/mol to 9000 g/mol, and at least one trifunctional polyether polyol, wherein the trifunctional polyether polyol is a copolymer of alkylene oxide and end-capped with 10 wt % to 28 wt %, by the total weight of the trifunctional polyether polyol, of ethylene oxide, and has a number average molecular weight from 5000 g/mol to 8000 g/mol, wherein the bifunctional polyether polyol and the trifunctional polyether polyol are present in a parts by weight ratio from 4:1 to 2.5:1, and wherein the polyisocyanate and the polyol blend are present in a parts by weight ratio of from 1:7 to 1:2.5.

### FIELD OF THE DISCLOSURE

The present invention relates to a novel one-component type polyurethane prepolymer composition, which is especially suitable for waterproofing coating applications.

### INTRODUCTION

Hitherto, polyurethane prepolymer compositions have been widely used in applications to, for example, sealants, inner and outer use adhesives, and waterproofing materials for roofs, wall surfaces, etc. The polyurethane prepolymer compositions comprise reaction products of isocyanates and polyols. The polyurethane prepolymer compositions are roughly classified into a one-component type that could be cured by water in air and a two-component type in which a base compound containing a NCO terminated polyurethane prepolymer and a curing agent containing an active hydrogen compound are mixed to be cured during application.

The one-component type polyurethane prepolymer compositions do not require mixing operations during constructions, and hence the one-component type polyurethane prepolymer compositions have advantages in that workability can be simplified and curing failure caused by mixing mistake can be prevented.

The one-component type polyurethane prepolymer compositions are desired to have relatively low viscosities. First, low viscosity ensures good wettability on the surface, which helps the reaction between isocyanate end groups and the moisture in the environment, which further helps the formation of polymer network so that enables its good mechanical strength and adhesion to fillers. Second, low viscosity decreases usage of solvent, and in turn further lower volatile organic compounds (VOC) level of final coatings. Third, lower viscosity allows higher filler amount in formulations so that coatings are more cost-effective.

Toluene diisocyanate (TDI) or pure methylene diphenyl diisocyanate (MDI) mixture composed of approximately 50 weight percent (wt %) 4,4′-MDI and 50 wt % 2,4′-MDI, having an isocyanate equivalent weight of 125.5 (MDI-50) is commonly used as a reactant to prepare the one-component type polyurethane prepolymer compositions, and usually amounts to more than 50 wt % of the total weight of polyisocyanate as the reactant in order to achieve good performance.

However, TDI residual in the final coating may be concerned extremely harmful to the environment and human health since TDI has a high vapor pressure of 0.01 millimeters of mercury (mmHg) at 25 Celsius degree (° C.). Considering the above health hazard, people in the art are trying to use MDI to replace TDI for the one-component type polyurethane prepolymer compositions. MDI is classified as “low toxic” by the European Community and has a relatively low vapor pressure at 25° C. so that its residual in the final coating represents less hazards to human and to the environment. However, 4,4′-MDI has a melting point at about 38° C. that causes difficulties in both handling and storage in broad applications. Consequently, MDI-50 is one promising solution to achieve comparable performance with low toxic. But, MDI-50 is often facing supply issue. Due to the high demand of MDI-50, its economical problems are unavoidable.

In view of the above situations, an object of the present invention is to provide a one-component type polyurethane prepolymer composition having a flexible selection of different commonly used or other types of polyisocyanates to react with polyol blend while exhibiting desired or even better performances of low viscosity and high tear strength, with a suppressed cost increase. The present invention is especially suitable for waterproofing coating applications

### SUMMARY OF THE DISCLOSURE

The present invention provides a one-component type polyurethane prepolymer composition comprising a reaction product formed through a reaction between reactants comprising (a) at least one polyisocyanate, and (b) a polyol blend comprising at least one bifunctional polyether polyol, wherein the bifunctional polyether polyol is a homopolymer of propylene oxide, homopolymer of butylene oxide, or copolymer of alkylene oxide, and has a number average molecular weight (Mw) from 3000 grams per mole (g/mol) to 9000 g/mol, and at least one trifunctional polyether polyol, wherein the trifunctional polyether polyol is a copolymer of alkylene oxide and end-capped with 10 wt % to 28 wt %, by the total weight of the trifunctional polyether polyol, of ethylene oxide, and has an Mw from 5000 g/mol to 8000 g/mol, wherein the bifunctional polyether polyol and the trifunctional polyether polyol are present in a parts by weight ratio from 4:1 to 2.5:1, and wherein the polyisocyanate and the polyol blend are present in a parts by weight ratio of from 1:7 to 1:2.5.

### DETAILED DESCRIPTION OF THE DISCLOSURE

The present invention relates to a novel one-component type polyurethane prepolymer composition, which is especially suitable for waterproofing coating applications. A one-component type polyurethane prepolymer composition comprises a reaction product formed through a reaction between reactants comprising (a) at least one polyisocyanate, and (b) a polyol blend comprising at least one bifunctional polyether polyol, wherein the bifunctional polyether polyol is a homopolymer of propylene oxide, homopolymer of butylene oxide, or copolymer of alkylene oxide, and has an Mw from 3000 g/mol to 9000 g/mol, and at least one trifunctional polyether polyol, wherein the trifunctional polyether polyol is a copolymer of alkylene oxide and end-capped with 10 wt % to 28 wt %, by the total weight of the trifunctional polyether polyol, of ethylene oxide, and has an Mw from 5000 g/mol to 8000 g/mol, wherein the bifunctional polyether polyol and the trifunctional polyether polyol are present in a parts by weight ratio from 4:1 to 2.5:1, and wherein the polyisocyanate and the polyol blend are present in a parts by weight ratio of from 1:7 to 1:2.5.

Polyisocyanate

The one-component type polyurethane prepolymer composition comprises a reaction product formed through a reaction between reactants comprising at least one polyisocyanate.

The polyisocyanate for the purposes of the present invention is an organic compound comprising two or more than two reactive isocyanate groups per molecule, i.e., the functionality is not less than 2. When the polyisocyanates used or a mixture of two or more polyisocyanates do not have a unitary functionality, the number-weighted average functionality of the polyisocyanate used will be not less than 2.

Suitable organic polyisocyanates are the aliphatic, cycloaliphatic, aryliphatic and preferably aromatic polyisocyanates including, but not limited to, alkylene diisocyanates having from 4 to 12 carbon atoms in the alkylene moiety, such as 1,12 dodecane diisocyanate, 2-methylpentamethylene 1,5-diisocyanate, tetramethylene 1,4-diisocyanate, hexamethylene 1,6-diisocyanate; cycloaliphatic diisocyanates such as cyclohexane 1,3- and 1,4-diisocyanate, 1-isocyanato-3,3,5-trimethyl-5-isocyanatomethylcyclohexane (IPDI), 2,4- and 2,6-hexahydrotoluene diisocyanate and the corresponding isomer mixtures 4,4′-, 2,2′- and 2,4′-dicyclohexylmethane diisocyanate and the corresponding isomer mixtures, and preferably aromatic diisocyanates and polyisocyanates such as 2,4- and 2,6-TDI and the corresponding isomer mixtures, 4,4′-, 2,4′- and 2,2′-MDI, polymethylene polyphenyl isocyanates, mixtures of 4,4′-, 2,4′- and 2,2′-MDI and polymethylene polyphenyl isocyanates (PMDI), and mixtures of the PMDI and TDI.

Further, the isocyanate is present in a comparative ratio to the polyols in the range of from 7:1 to 14:1 NCO to OH equivalents.

Frequent use is also made of modified polyisocyanates, i.e. products obtained by chemical conversion of organic polyisocyanates and having two or more than two reactive isocyanate groups per molecule. Polyisocyanates comprising ester, urea, biuret, allophanate, carbodiimide, isocyanurate, uretdione, carbamate and/or urethane groups may be mentioned in particular. In one embodiment, the polyisocyanate useful of the present invention is liquid carbodiimide modified MDI, which is commercially available from The Dow Chemical Company as ISONATE™ 143L isocyanates.

In one embodiment, the polyisocyanates useful of the present invention are TDI, especially 2,4-TDI or 2,6-TDI or mixtures of 2,4- and 2,6-TDI.

In one embodiment, the polyisocyanates useful of the present invention are MDI, especially 2,2′-MDI or 2,4′-MDI or 4,4′-MDI or oligomeric MDI, which is also known as polyphenyl-polymethylene isocyanate, or mixtures of two or three of the aforementioned MDI, or crude MDI, which is obtained in the production of MDI, or mixtures of at least one oligomer of MDI and at least one aforementioned low molecular weight MDI derivative.

In one embodiment, the polyisocyanate useful of the present invention is MDI-50, which is commercially available from The Dow Chemical Company as ISONATE™ 50 OP Pure MDI.

Crude MDI, obtained as an intermediate in the production of MDI, is more particularly such a mixture of MDI-based polyfunctional isocyanates having different functionalities.

Polyol Blend

The one-component type polyurethane prepolymer composition comprises a reaction product formed through a reaction between reactants further comprises a polyol blend.

As used herein the term polyol means those materials having at least one group containing an active hydrogen atom capable of undergoing reaction with an isocyanate. Polyether polyols can be obtained in conventional manners by reacting alkylene oxides, such as ethylene, propylene or butylene oxide, with an initiator having two active hydrogen atoms for a bifunctional polyether polyol and with an initiator having three active hydrogen atoms for a trifunctional polyether. Examples of suitable initiators include ethylene glycol, diethylene glycol, propylene glycol, dipropylene glycol, tripropylene glycol, 1,4-butanediol, 1,6-hexane diol; cycloaliphatic diols such as 1,4-cyclohexane diol, glycerine, trimethanoyl propane and triethanolamine. Catalysts for the polymerization can be either anionic or cationic with catalysts such as KOH, boron trifluoride, or a double cyanide complex (DMC) catalysts such as zinc hexacyanocobaltate.

The polyol blend useful in the present invention comprises at least one bifunctional polyether polyol, wherein the bifunctional polyether polyol is a homopolymer of propylene oxide, homopolymer of butylene oxide, or copolymer of alkylene oxide, and has an Mw from 3000 g/mol to 9000 g/mol.

The bifunctional polyether polyols are obtained by homopolymerization of propylene oxide, homopolymerization of butylene oxide, or copolymerization of alkylene oxides. Suitable examples of the bifunctional polyether polyols include, but not limited to, polypropylene oxide, polybutylene oxide or block copolymer of polyalkylene oxides.

The bifunctional polyether polyols useful in the present invention have an Mw from 3000 g/mol to 9000 g/mol, preferably from 3000 g/mol to 5000 g/mol. Suitable example of bifunctional polyether polyol having an Mw from 3000 g/mol to 5000 g/mol useful of the present invention is commercially available from The Dow Chemical Company as VORANOL™ 4000LM polyol.

In an embodiment, the bifunctional polyether polyols useful in the present invention comprises a first bifunctional polyether polyol and a second bifunctional polyether polyol. The first bifunctional polyether polyol has an Mw from 3000 g/mol to 5000 g/mol. The second bifunctional polyether polyol has an Mw from 7000 g/mol to 9000 g/mol, which is commercially available from The Dow Chemical Company as VORANOL™ 8000LM polyol.

The polyol blend useful in the present invention further comprises at least one trifunctional polyether polyol, wherein the trifunctional polyether polyol is a copolymer of alkylene oxide and end-capped with 10 wt % to 28 wt %, by the total weight of the trifunctional polyether polyol, of ethylene oxide, and has an Mw from 5000 g/mol to 8000 g/mol.

The trifunctional polyether polyols are obtained by copolymerization of alkylene oxides. Suitable examples of the trifunctional polyether polyols include, but not limited to, trimethylolpropane or glycerol initiated block copolymer of alkylene oxides.

The trifunctional polyether polyols useful in the present invention have an Mw from 5000 g/mol to 8000 g/mol, preferably from 5000 g/mol to 7000 g/mol. Suitable example is commercially available from The Dow Chemical Company as VORANOL™ CP 6001 polyol.

The weight ratio of the bifunctional polyether polyol(s) to the trifunctional polyether polyol(s) is 2.5:1 or more, or even 3:1 or more, and at the same time, 4:1 or less, or even 3.5:1 or less.

The weight ratio of the polyisocyanate and the polyol blend is 1:7 or more, 1:6 or more, or even 1:5 or more, and at the same time, 1:2.5 or less, 1:3 or less, or even 1:4 or less.

Additives

The one-component type polyurethane prepolymer composition of the present invention may further comprise additives within a range not impairing the object of the present invention. As the additives, there may be given a plasticizer, a weathering stabilizer, a filler, a storage stability-improving agent (dehydration agent), a colorant, an organic solvent, a curing catalyst, a defoaming agent, a wetting dispersant, and other conventionally used components, so far as they consistent with the objectives of the invention. Any one kind of those additives may be used alone, or two or more kinds thereof may be used in combination. It should be noted that the additives may be added and mixed after the one-component type polyurethane prepolymer composition is formed or may be added and mixed when preparing or forming the reaction product of the present invention to form the one-component type polyurethane prepolymer composition through one-step method to reduce the time.

Optionally, from 0 wt % to 16 wt %, preferably from 12 wt % to 16 wt %, based on the total weight of the one-component type polyurethane prepolymer composition, a plasticizer is used for the purposes of decreasing the viscosity of the one-component type polyurethane prepolymer composition to improve workability after curing of the one-component type polyurethane prepolymer composition. Specific examples thereof include: low-molecular-weight plasticizers, for example, phthalic acid esters, such as dioctyl phthalate, diisononyl phthalate, dibutyl phthalate, and butyl benzyl phthalate, and aliphatic carboxylic acid esters, such as dioctyl adipate, diisodecyl succinate, dibutyl sebacate, and butyl oleate; and high-molecular-weight plasticizers each of which has an Mw of 1,000 g/mol or more and does not react with an isocyanate group, for example, a compound obtained by etherifying or esterifying a polyalkylene-based polyol or a polyoxyalkylene based monool, and polystyrenes, such as poly-a-methylstyrene and polystyrene.

The one-component type polyurethane prepolymer composition of the present invention is excellent in weather resistance and has a prolonged shelf life. Hence a weathering stabilizer may not be added thereto. However, optionally, from 0 to 1 wt %, based on the total weight of the one-component type polyurethane prepolymer composition, a weathering stabilizer may be added for the purpose of preventing oxidation, light degradation, and thermal degradation of the one-component type polyurethane prepolymer composition to further improve weather resistance and heat resistance thereof. Examples of the weathering stabilizer include a hindered amine-based light stabilizer, a hindered phenol based antioxidant, and a UV absorber. Any one kind of those weathering stabilizers may be used alone, or two or more kinds thereof may be used in combination.

Optionally, from 0 wt % to 60 wt %, preferably from 40 wt % to 60 wt %, more preferably from 40 wt % to 50wt %, based on the total weight of the one-component type polyurethane prepolymer composition, a filler is used for the purposes of serving as an extender for the one-component type polyurethane prepolymer composition and reinforcing the physical properties of a cured product. On the other hand, the filler can also lower the cost of the one-component type polyurethane prepolymer composition. Specific examples thereof include mica, kaolin, zeolite, graphite, diatomaceous earth, terra alba, clay, talc, slate powder, silicic anhydride, quartz fine powder, aluminum powder, zinc powder, synthetic silica, such as precipitated silica, inorganic powdery fillers. Such as calcium carbonate, magnesium carbonate, alumina, calcium oxide, and magnesium oxide, fibrous fillers, such as glass fibers and carbon fibers, inorganic balloon fillers, such as glass balloons, Shirasu balloons, silica balloons, and ceramic balloons, and a filler obtained by treating a surface of any of the above-mentioned fillers with an organic substance, such as a fatty acid, wood powder, walnut shell powder, chaff powder, pulp powder, cotton chips, rubber powder, fine powder of a thermoplastic or thermosetting resin, powder or a hollow body of polyethylene or the like, and organic balloon fillers, such as saran microballoons, as well as flame retardancy-imparting fillers, such as magnesium hydroxide and aluminum hydroxide. The particle diameter of the filler is preferably from 0.01 micrometer (um) to 1,000 um.

Optionally, from 0 wt % to 15 wt %, preferably from 5 wt % to 13 wt %, based on the total weight of the one-component type polyurethane prepolymer composition, an organic solvent is used for the purpose of decreasing the viscosity of the one-component type polyurethane prepolymer composition to improve the workability of extrusion and application. As the organic solvent, any organic solvent can be used without any particular limitation as long as the organic solvent does not react with the reactants of the present invention. Specific examples thereof include: ester-based solvents, such as ethyl acetate, ketone-based solvents, such as methyl ethyl ketone; aliphatic solvents, such as n-hexane; naphthene-based solvents, such as methylcyclohexane, ethylcyclohexane, and dimethylcyclohexane; and aromatic solvents, such as toluene and xylene.

Optionally, from 0 to 5 wt %, based on the total weight of the one-component type polyurethane prepolymer composition, an aliphatic isocyanate crosslinker is used in the preparation of the one-component type polyurethane prepolymer composition. The aliphatic isocyanate crosslinker may be an aliphatic diisocyanate such as hexamethylene diisocyanate (HDI); a trimer of such diisocyanate; an aliphatic triisocyanate; and also a polymer derived from these homopolymerized or copolymerized monomers, or derived from the addition of a polyol or of a polyamine with one or more of these monomers, with the polyol or the polyamine possibly being a polyether, a polyester, a polycarbonate, or a polyacrylate. In some embodiments, the aliphatic isocyanate crosslinker has an NCO functionality equal to or above 3.

Optionally, from 0 to 0.5 wt %, based on the total weight of the one-component type polyurethane prepolymer composition, a storage stability-improving agent (dehydration agent) is used for the purpose of improving the storage stability of the one-component type polyurethane prepolymer composition. Specific examples thereof include vinyltrimethoxysilane, calcium oxide, and p-toluenesulfonyl isocyanate (PTSI), which function as the dehydration agent by a reaction with water that is present in the one-component type polyurethane prepolymer composition.

Optionally, from 0 to 2 wt %, based on the total weight of the one-component type polyurethane prepolymer composition, a colorant is used for the purpose of coloring the one-component type composition to impart a design property to a cured product. Specific examples thereof include: inorganic pigments, such as titanium oxide and iron oxide; organic pigments, such as copper phthalocyanine; and carbon black.

Optionally, from 0 to 15 wt %, preferably from 0.1 wt % to 13 wt %, based on the total weight of the one-component type polyurethane prepolymer composition, a curing catalyst is used in the preparation of the one-component type polyurethane prepolymer composition. The curing catalyst may be organic tin catalysts, amine catalysts and organic and acid catalysts.

Optionally, from 0 to 0.5 wt %, preferably from 0.2 wt % to 0.4 wt %, based on the total weight of the one-component type polyurethane prepolymer composition, a defoaming agent is used in the preparation of the one-component type polyurethane prepolymer composition. Commercially available defoaming agents useful of the present invention include FT-301 and FT-3065 available from Fit Brother, BYK-A 530, BYK-A 535 and BYK-066 N from BYK.

Optionally, from 0 to 0.5 wt %, preferably from 0.1 wt % to 0.4 wt %, based on the total weight of the one-component type polyurethane prepolymer composition, a wetting dispersant is used in the preparation of the one-component type polyurethane prepolymer composition. Commercially available wetting dispersants useful of the present invention include FT-203 available from Fit Brother, BYK-W 980 available from BYK.

The one-component type polyurethane prepolymer composition of the present invention can be produced by mixing the above mentioned reactants and the necessary additives. In some embodiments, the reactants are present from 25 wt % to 100 wt %, or from 25 wt % to 50 wt %, or from 25 wt % to 37 wt %, based on the total weight of one-component type polyurethane prepolymer composition.

The preparation of the one-component type polyurethane prepolymer composition is in any way known to those of ordinary skill in the art. The one-component type polyurethane prepolymer compositions of the present invention are prepared according to any conventional method, for example, under the environment wherein moisture is eliminated as far as possible, for example, under a reduced pressure.

In an embodiment, the one-component type polyurethane prepolymer composition is prepared by reacting the above mentioned polyisocyanate and the polyol blend to form a prepolymer, and then mix with the additives.

Preparation of MDI prepolymers is in any way known to those of ordinary skill in the art, and includes condensation polymerization. The stoichiometry of the MDI prepolymer formulation disclosure is such that the diisocyanate is present in excess, and the MDI prepolymer is NCO group terminated. In some embodiments, the molar ratio of NCO group to OH group is much higher than 2, therefor the product is the mixture of MDI prepolymer and unreacted MDI monomer. The stoichiometry ratio is also referred to as an isocyanate index, which is the equivalents of isocyanate groups (i.e., NCO moieties) present, divided by the total equivalents of isocyanate-reactive groups (e.g., OH moieties) present. Considered in another way, the isocyanate index is the ratio of the isocyanate groups over the isocyanate reactive hydrogen atoms present in a formulation, given as a ratio and may be given as a percentage when multiplied by 100. Thus, the isocyanate index expresses the isocyanate actually used in a formulation with respect to the amount of isocyanate theoretically required for reacting with the amount of isocyanate-reactive hydrogen used in a formulation. The preparation of MDI prepolymer and the MDI prepolymer composition is free of water.

Curing is performed by exposing the one-component type polyurethane prepolymer composition to moisture. This is mainly done in at least two ways. In one approach, the moisture is simply atmospheric moisture, which comes into contact with the mixture and reacts with the isocyanate groups. In the other main approach, liquid water and/or steam is added into the one-component type polyurethane prepolymer compositions.

Curing can be performed at ambient temperature, or at some elevated temperature, such as up to 80° C.

In certain applications, such as general horizontal flat surface of roof, corner part of roof connected with vertical wall, the one-component type polyurethane prepolymer composition is spread upon the ground, leveled and smoothed, and then allowed to cure at ambient temperature, typically with atmospheric moisture. Water may be sprayed onto the spread one-component type polyurethane prepolymer composition if desired or necessary (as may be the case in a dry climate or under high temperature conditions) in order to speed the cure. In installations of this type, a certain amount of open time is needed, so that the one-component type polyurethane prepolymer composition remains workable long enough for the mixing, spreading, leveling and smoothing steps can be performed.

In the present invention, the technical features in each preferred technical solution and more preferred technical solution can be combined with each other to form new technical solutions unless indicated otherwise. For briefness, the specification omits the descriptions for these combinations. However, all the technical solutions obtained by combining these technical features should be deemed as being literally described in the present specification in an explicit manner.

In order to further illustrate this invention the following examples are presented. However, it should be understood that the invention is not limited to these illustrative examples.

### EXAMPLES

I. Raw Materials

Raw materials and components used in this disclosure are listed below.

TABLE 1
Raw materials and components

| Material | Description | Supplier |
|---|---|---|
| ISONATE ™ 50 | MDI-50 | The Dow |
| OP Pure MDI | | Chemical |
| | | Company |
| Desmodur CD-C | Polycarbodiimide-modified diphenylmethane-4,4′- | Covestro |
| MDI | diisocyanate with functionality at 2.1 | Company |
| VORANATE ™ T- | TDI | The Dow |
| 80 Type I TDI | | Chemical |
| | | Company |
| VORANOL ™ | Bifunctional polyether polyol being a | The Dow |
| 2000LM polyol | homopolymer of propylene oxide; | Chemical |
| | Mw: 2000 g/mol | Company |
| VORANOL ™ | Bifunctional polyether polyol being a | The Dow |
| 4000LM polyol | homopolymer of propylene oxide; | Chemical |
| | Mw: 4000 g/mol | Company |
| VORANOL ™ | Bifunctional polyether polyol being a | The Dow |
| 8000LM polyol | homopolymer of propylene oxide; | Chemical |
| | Mw: 8000 g/mol | Company |
| VORANOL ™ CP- | Trifunctional polyether polyol being a copolymer | The Dow |
| 3001 polyol | of propylene oxide, end-capped with 8.5 wt %, | Chemical |
| | based on the total weight of the trifunctional | Company |
| | polyether polyol, of ethylene oxide; | |
| | Mw: 3000 g/mol | |
| VORANOL ™ | Trifunctional polyether polyol being a copolymer | The Dow |
| 4701 polyol | of propylene oxide, end-capped with 13 wt %, | Chemical |
| | based on the total weight of the trifunctional | Company |
| | polyether polyol, of ethylene oxide; | |
| | Mw: 5000 g/mol | |
| VORANOL™ CP | Trifunctional polyether polyol being a copolymer | The Dow |
| 6001 polyol | of propylene oxide, end-capped with 15.6 wt %, | Chemical |
| | based on the total weight of the trifunctional | Company |
| | polyether polyol, of ethylene oxide; | |
| | Mw: 6000 g/mol | |
| VORANOL ™ | Trifunctional polyether polyols being a copolymer | The Dow |
| 1447 polyol | of propylene oxide, end-capped with 71.2 wt %, | Chemical |
| | based on the total weight of the trifunctional | Company |
| | polyether polyol, of ethylene oxide; | |
| | Mw: 6000 g/mol | |
| VORANOL ™ CP | Trifunctional polyether polyols being a copolymer | The Dow |
| 4610 polyol | of propylene oxide, end-capped with 12.5 wt %, | Chemical |
| | based on the total weight of the trifunctional | Company |
| | polyether polyol, of ethylene oxide; | |
| | Mw: 4600 g/mol | |
| Chlorinated | Plasticizer | Danyang |
| paraffin | | Chemical |
| | | Additives Co., |
| | | Ltd. |
| BYK-W 980 | Wetting dispersant | BYK |
| wetting dispersant | | |
| 800 mesh calcium | Filler | Omya |
| carbonate | | |
| S-150 solvent | Aromatic solvent oil | Peng Chen New |
| | | Materials |
| | | Technology Co., |
| | | Ltd. |
| DABCO T-12 | Curing catalyst | Air Products and |
| catalyst | | Chemicals |
| DMDEE catalyst | 2,2′-dimorpholinyldiethyl ether curing catalyst | Qingdao Hengke |
| BYK-066 N | Defoaming agent | BYK |
| defoaming agent | | |

II. Test Methods

(a) Viscosity measurement: viscosity (unit: pascal-second (Pa·s)) was measured by advanced Rhometric Expansion System G2 (ARES G2) at the following condition: 25 millimeter (mm) steel parallel plate, temperature at 25° C., shear rate at 0.1/second and screen for 180 seconds.

(b) Tear Strength Test:

Film Preparation

Ethacure 300 curative, available from Albemarle Company, was added into the prepolymer composition. The amounts of curative may be calculated by the following formula:

$${C}_{100 p} = \frac{NCO \% \times {C}_{ew} \times \% Theory}{4202}$$

Wherein “C₁₀₀ₚ” is the parts curative per 100 parts prepolymer composition, “NCO %”, also called isocyanate content, is the percent of the remaining NCO content of the prepolymer composition, determined by reaction with excess di-n-butylamine and back titration with standardized hydrochloric acid. “C_{ew}” is the equivalent weight of the curative, and “% Theory” is the stoichiometry for the curative. In general, Ethacure 300 curative has an equivalent weight of 107 and 90% to 95% stoichiometry. Thus, for example, the calculated amount of a curative with an equivalent weight of 107 and 95% stoichiometry cured with a prepolymer composition having 4.8 NCO % would be 11.6 parts of curative per 100 parts prepolymer composition on a mass basis.

Then, the mixture of prepolymer composition and Ethacure 300 curative was blended by a SpeedMixer laboratory mixer system from FlackTek Inc. at 3000 revolutions per minute (RPM) for 30 seconds, and turned to dark brown, deep purple or even black. Then, the mixture was poured onto a release paper and a film was formed. The film was made at the thickness about 1.0 mm to 1.3 mm, and cured at 80° C. for 30 minutes. After stripping from the release paper, the film was further post cured at 60° C. for 24 hours.

Tear Strength Test

Tear strength test was applied through Trousers Type Method, also called the Double Tongue Method. The film was cut by a molder to trousers like shape with a V-notch fixture. The thickness of the sample was measured prior to the tear strength test. When clamping, sample tongue is clamped in the center of clamps, symmetrical. Two legs of sample, parallel to the direction of tearing, are clamped symmetrically in removable clamps. Pay attention to ensuring each tongue is fixed in clamps, so that tear is parallel to tearing direction when tear starts. Start the machine to tear the sample from both tongue until it was fully broken, marking the end of this test. Tearing load and tearing length of each sample is recorded. The observation should be done on whether tear is processed in the direction of applied force and whether yarns slip away from the fabric. If the sample does not slip away from the clamps and tear is conducted along the direction of applied force, the test results can be acknowledged, otherwise, removed. Tear strength is obtained by dividing the maximum tear load by the thickness of each sample. The test was repeated 3 times to calculate an average tear strength.

III. Examples

Inventive Example 1 (IE1)

7.3 grams (g) VORANOL™ 4000LM polyol and 2.7 g VORANOL™ CP 6001 polyol were mixed in a flask with mechanical stiffing to prepare a polyol blend. Then, the polyol blend was heated to 120° C. At the condition that the polyol blend was controlled at the temperature range of from 115° C. to 120° C. and that the vacuum level of the flask was controlled at −0.09 megapascal (MPa) or less, the polyol blend was dehydrated for 2 hours to decrease water content to a level lower than 200 parts per million (ppm).

When the polyol blend was cooled down naturally at room temperature to 65° C., 2.8 g Desmodur CD-C MDI was added into the flask. The mixture in the flask was being continuously and mechanically stirred and was allowed to react for 7 hours to obtain the inventive one-component type polyurethane prepolymer composition.

Inventive Example 2 (IE2)

7.3 g VORANOL™ 4000LM polyol and 2.7 g VORANOL™ CP 6001 polyol were mixed in a flask with mechanical stiffing to prepare a polyol blend. Then, the polyol blend was heated to 120° C. At the condition that the polyol blend was controlled at the temperature range of from 115° C. to 120° C. and that the vacuum level of the flask was controlled at −0.09 MPa or less, the polyol blend was dehydrated for 2 hours to decrease water content to a level lower than 200 ppm.

When the polyol blend was cooled down naturally at room temperature to 65° C., 2.4 g ISONATE™ 50 OP Pure MDI was added into the flask. The mixture in the flask was being continuously and mechanically stirred and was allowed to react for 7 hours to obtain the inventive one-component type polyurethane prepolymer composition.

Inventive Example 3 (IE3)

7.3 g VORANOL™ 4000LM polyol and 2.7 g VORANOL™ CP 6001 polyol were mixed in a first flask with mechanical stiffing to prepare a polyol blend. Then, the polyol blend was heated to 120° C. At the condition that the polyol blend was controlled at the temperature range of from 115° C. to 120° C. and that the vacuum level of the flask was controlled at −0.09 MPa or less, the polyol blend was dehydrated for 2 hours to decrease water content to a level lower than 200 ppm.

1.9 g Desmodur CD-C MDI and 0.8 g ISONATE™ 50 OP Pure MDI were mixed in a second flask with mechanical stiffing to prepare a polyisocyanate blend.

When the polyol blend was cooled down naturally at room temperature to 65° C., the polyisocyanate blend was poured into the first flask. The mixture in the first flask was being continuously and mechanically stirred and was allowed to react for 7 hours to obtain the inventive one-component type polyurethane prepolymer composition.

Inventive Example 4 (IE4)

6.0 g VORANOL™ 4000LM polyol, 2.0 g VORANOL™ CP 6001 polyol and 2.0 g VORANOL™ 8000LM polyol were mixed in a flask with mechanical stiffing to prepare a polyol blend. Then, the polyol blend was heated to 120° C. At the condition that the polyol blend was controlled at the temperature range of from 115° C. to 120° C. and that the vacuum level of the flask was controlled at −0.09 MPa or less, the polyol blend was dehydrated for 2 hours to decrease water content to a level lower than 200 ppm.

When the polyol blend was cooled down naturally at room temperature to 65° C., 2.7 g Desmodur CD-C MDI was added into the flask. The mixture in the flask was being continuously and mechanically stirred and was allowed to react for 7 hours to obtain the inventive one-component type polyurethane prepolymer composition.

Inventive Example 5 (IE5)

6.0 g VORANOL™ 4000LM polyol, 2.0 g VORANOL™ CP 6001 polyol and 2.0 g VORANOL™ 8000LM polyol were mixed in a flask with mechanical stiffing to prepare a polyol blend. Then, the polyol blend was heated to 120° C. At the condition that the polyol blend was controlled at the temperature range of from 115° C. to 120° C. and that the vacuum level of the flask was controlled at −0.09 MPa or less, the polyol blend was dehydrated for 2 hours to decrease water content to a level lower than 200 ppm.

When the polyol blend was cooled down naturally at room temperature to 65° C., 2.4 g ISONATE™ 50 OP Pure MDI was added into the flask. The mixture in the flask was being continuously and mechanically stirred and was allowed to react for 7 hours to obtain the inventive one-component type polyurethane prepolymer composition.

Inventive Example 6 (IE6)

6.0 g VORANOL™ 4000LM polyol, 2.0 g VORANOL™ CP 6001 polyol and 2.0 g VORANOL™ 8000LM polyol were mixed in a first flask with mechanical stiffing to prepare a polyol blend. Then, the polyol blend was heated to 120° C. At the condition that the polyol blend was controlled at the temperature range of from 115° C. to 120° C. and that the vacuum level of the flask was controlled at −0.09 MPa or less, the polyol blend was dehydrated for 2 hours to decrease water content to a level lower than 200 ppm.

1.8 g Desmodur CD-C MDI and 0.8 g ISONATE™ 50 OP Pure MDI were mixed in a second flask with mechanical stiffing to prepare a polyisocyanate blend.

When the polyol blend was cooled down naturally at room temperature to 65° C., the polyisocyanate blend was poured into the first flask. The mixture in the first flask was being continuously and mechanically stirred and was allowed to react for 7 hours to obtain the inventive one-component type polyurethane prepolymer composition.

Inventive Example 7 (IE7)

36.5 g VORANOL™ 4000LM polyol and 13.5 g VORANOL™ CP 3001 polyol were mixed in a flask with mechanical stiffing to prepare a polyol blend. Then, the polyol blend was heated to 120° C. At the condition that the polyol blend was controlled at the temperature range of from 115° C. to 120° C. and that the vacuum level of the flask was controlled at −0.09 MPa or less, the polyol blend was dehydrated for 2 hours to decrease water content to a level lower than 200 ppm.

When the polyol blend was cooled down naturally at room temperature to 65° C., 13.1 g ISONATE™ 50 OP Pure MDI was added into the flask. The mixture in the flask was being continuously and mechanically stirred and was allowed to react for 7 hours to obtain the inventive one-component type polyurethane prepolymer composition.

Inventive Example 8 (IE8)

36.5 g VORANOL™ 4000LM polyol and 13.5 g VORANOL™ CP 4610 polyol were mixed in a flask with mechanical stiffing to prepare a polyol blend. Then, the polyol blend was heated to 120° C. At the condition that the polyol blend was controlled at the temperature range of from 115° C. to 120° C. and that the vacuum level of the flask was controlled at −0.09 MPa or less, the polyol blend was dehydrated for 2 hours to decrease water content to a level lower than 200 ppm.

When the polyol blend was cooled down naturally at room temperature to 65° C., 12.5 g ISONATE™ 50 OP Pure MDI was added into the flask. The mixture in the flask was being continuously and mechanically stirred and was allowed to react for 7 hours to obtain the inventive one-component type polyurethane prepolymer composition.

Inventive Example 9 (IE9)

195.6 g VORANOL™ 4000LM polyol, 72.3 g VORANOL™ CP 6001 polyol, 108.4 g chlorinated paraffin, 455.1 g 800 mesh calcium carbonate and 1.2 g BYK-W 980 wetting dispersant were mixed in a flask with mechanical stirring to prepare a mixture. Then, the mixture was heated to 120° C. At the condition that the mixture was controlled at the temperature range of from 115° C. to 120° C. and that the vacuum level of the flask was controlled at −0.09 MPa or less, the mixture was dehydrated for 2 hours to decrease water content to a level lower than 200 ppm.

When the mixture was cooled down naturally at room temperature to 65° C., 51.6 g ISONATE™ 50 OP Pure MDI, 1.2 g BYK-W 980 wetting dispersant and 83.2 g S-150 solvent were added into the flask. The mixture in the flask was being continuously and mechanically stirred and was allowed to react for 30 minutes. Then, the mixture was heated to 85° C. The mixture then was being continuously and mechanically stirred and was allowed to react for 2 hours while the temperature of the mixture was controlled at a range of 80° C. to 85° C.

The mixture was then cooled down naturally at room temperature to 60° C. 0.9 g DABCO T-12 catalyst and 1.3 g DMDEE catalyst dissolved in 27.7 g S-150 solvent, and 1.5 g BYK-066 N defoaming agent were further added into the flask. The mixture was mixed under 60° C. for 30 minutes.

Then, the mixture was defoamed for 5 minutes at a pressure of −0.09 MPa or less controlled by vacuuming to obtain the inventive one-component type polyurethane prepolymer composition.

Inventive Example 10 (IE10)

196.2 g VORANOL™ 4000LM polyol, 72.6 g VORANOL™ CP 6001 polyol, 121.2 g chlorinated paraffin, 446.5 g 800 mesh calcium carbonate and 1.55 g BYK-W 980 wetting dispersant were mixed in a flask with mechanical stirring to prepare a mixture. Then, the mixture was heated to 120° C. At the condition that the mixture was controlled at the temperature range of from 115° C. to 120° C. and that the vacuum level of the flask was controlled at −0.09 MPa or less, the mixture was dehydrated for 2 hours to decrease water content to a level lower than 200 ppm.

When the mixture was cooled down naturally at room temperature to 65° C., 35.7 g VORANATE™ T-80 Type I TDI, 1.55 g BYK-W 980 wetting dispersant and 90.9 g S-150 solvent were added into the flask. The mixture in the flask was being continuously and mechanically stirred and was allowed to react for 30 minutes. Then, the mixture was heated to 85° C. The mixture then was being continuously and mechanically stirred and was allowed to react for 2 hours while the temperature of the mixture was controlled at a range of 80° C. to 85° C.

The mixture was then cooled down naturally at room temperature to 60° C. 1.0 g DABCO T-12 catalyst and 0.4 g DMDEE catalyst dissolved in 30.3 g S-150 solvent, and 2.1 g BYK-066 N defoaming agent were further added into the flask. The mixture was mixed under 60° C. for 30 minutes.

Then, the mixture was defoamed for 5 minutes at a pressure of −0.09 MPa or less controlled by vacuuming to obtain the inventive one-component type polyurethane prepolymer composition.

Comparative Example 1 (CE1)

7.3 g VORANOL™ 2000LM polyol and 2.7 g VORANOL™ 4701 polyol were mixed in a flask with mechanical stiffing to prepare a polyol blend. Then, the polyol blend was heated to 120° C. At the condition that the polyol blend was controlled at the temperature range of from 115° C. to 120° C. and that the vacuum level of the flask was controlled at −0.09 MPa or less, the polyol blend was dehydrated for 2 hours to decrease water content to a level lower than 200 ppm.

When the polyol blend was cooled down naturally at room temperature to 65° C., 3.5 g Desmodur CD-C MDI was added into the flask. The mixture in the flask was being continuously mechanically stirred and was allowed to react for 7 hours to obtain the inventive one-component type polyurethane prepolymer composition.

Comparative Example 2 (CE2)

7.3 g VORANOL™ 2000LM polyol and 2.7 g VORANOL™ 4701 polyol were mixed in a flask with mechanical stiffing to prepare a polyol blend. Then, the polyol blend was heated to 120° C. At the condition that the polyol blend was controlled at the temperature range of from 115° C. to 120° C. and that the vacuum level of the flask was controlled at −0.09 MPa or less, the polyol blend was dehydrated for 2 hours to decrease water content to a level lower than 200 ppm.

When the polyol blend was cooled down naturally at room temperature to 65° C., 3.0 g ISONATE™ 50 OP Pure MDI was added into the flask. The mixture in the flask was being continuously and mechanically stirred and was allowed to react for 7 hours to obtain the inventive one-component type polyurethane prepolymer composition.

Comparative Example 3 (CE3)

7.3 g VORANOL™ 2000LM polyol and 2.7 g VORANOL™ 4701 polyol were mixed in a first flask with mechanical stiffing to prepare a polyol blend. Then, the polyol blend was heated to 120° C. At the condition that the polyol blend was controlled at the temperature range of from 115° C. to 120° C. and that the vacuum level of the flask was controlled at −0.09 MPa or less, the polyol blend was dehydrated for 2 hours to decrease water content to a level lower than 200 ppm.

2.3 g Desmodur CD-C MDI and 1.0 g ISONATE™ 50 OP Pure MDI were mixed in a second flask with mechanical stiffing to prepare a polyisocyanate blend.

When the polyol blend was cooled down naturally at room temperature to 65° C., the polyisocyanate blend was poured into the first flask. The mixture in the first flask was being continuously mechanically stirred and was allowed to react for 7 hours to obtain the inventive one-component type polyurethane prepolymer composition.

Comparative Example 4 (CE4)

36.5 g VORANOL™ 4000LM polyol and 13.5 g VORANOL™ 1447 polyol were mixed in a flask with mechanical stiffing to prepare a polyol blend. Then, the polyol blend was heated to 120° C. At the condition that the polyol blend was controlled at the temperature range of from 115° C. to 120° C. and that the vacuum level of the flask was controlled at −0.09 MPa or less, the polyol blend was dehydrated for 2 hours to decrease water content to a level lower than 200 ppm.

When the polyol blend was cooled down naturally at room temperature to 65° C., 12.5 g ISONATE™ 50 OP Pure MDI was added into the flask. The mixture in the flask was being continuously mechanically stirred and was allowed to react for 7 hours to obtain the inventive one-component type polyurethane prepolymer composition.

Comparative Example 5 (CE5)

181.5 g VORANOL™ 2000LM polyol, 82.9 g VORANOL™ 4701 polyol, 106.4 g chlorinated paraffin, 450.0 g 800 mesh calcium carbonate and 1.15 g BYK-W 980 wetting dispersant were mixed in a flask with mechanical stirring to prepare a mixture. Then, the mixture was heated to 120° C. At the condition that the mixture was controlled at the temperature range of from 115° C. to 120° C. and that the vacuum level of the flask was controlled at −0.09 MPa or less, the mixture was dehydrated for 2 hours to decrease water content to a level lower than 200 ppm.

When the mixture was cooled down naturally at room temperature to 65° C., 64.0 g ISONATE™ 50 OP Pure MDI, 1.15 g BYK-W 980 wetting dispersant and 81.9 g S-150 solvent were added into the flask. The mixture in the flask was being continuously and mechanically stirred and was allowed to react for 30 minutes. Then, the mixture was heated to 85° C. The mixture then was being continuously and mechanically stirred and was allowed to react for 2 hours while the temperature of the mixture was controlled at a range of 80° C. to 85° C.

The mixture was then cooled down naturally at room temperature to 60° C. 0.9 g DABCO T-12 catalyst and 1.3 g DMDEE catalyst dissolved in 27.3 g S-150 solvent, and 1.5 g BYK-066 N defoaming agent were further added into the flask. The mixture was mixed under 60° C. for 30 minutes.

Then, the mixture was defoamed for 5 minutes at a pressure of −0.09 MPa or less controlled by vacuuming to obtain the inventive one-component type polyurethane prepolymer composition.

Comparative Example 6 (CE6)

186.2 g VORANOL™ 2000LM polyol, 80.1 g VORANOL™ 4701 polyol, 120.1 g chlorinated paraffin, 442.4 g 800 mesh calcium carbonate and 1.5 g BYK-W 980 wetting dispersant were mixed in a flask with mechanical stirring to prepare a mixture. Then, the mixture was heated to 120° C. At the condition that the mixture was controlled at the temperature range of from 115° C. to 120° C. and that the vacuum level of the flask was controlled at −0.09 MPa or less, the mixture was dehydrated for 2 hours to decrease water content to a level lower than 200 ppm.

When the mixture was cooled down naturally at room temperature to 65° C., 44.6 g VORANATE™ T-80 Type I TDI, 1.5 g BYK-W 980 wetting dispersant and 90.1 g S-150 solvent were added into the flask. The mixture in the flask was being continuously and mechanically stirred and was allowed to react for 30 minutes. Then, the mixture was heated to 85° C. The mixture then was being continuously and mechanically stirred and was allowed to react for 2 hours while the temperature of the mixture was controlled at a range of 80° C. to 85° C.

The mixture was then cooled down naturally at room temperature to 60° C. 1.0 g DABCO T-12 catalyst and 0.4 g DMDEE catalyst dissolved in 30.0 g S-150 solvent, and 2.0 g BYK-066 N defoaming agent were further added into the flask. The mixture was mixed under 60° C. for 30 minutes.

Then, the mixture was defoamed for 5 minutes at a pressure of −0.09 MPa or less controlled by vacuuming to obtain the inventive one-component type polyurethane prepolymer composition.

The formulations and the test results for Inventive Examples 1-10 and Comparative Examples 1-6 are as reported in Tables 2, 3 and 4.

TABLE 2
Formulations and test results of Inventive Examples 1-6 and Comparative Examples 1-3

| | IE1 | IE2 | IE3 | IE4 | IE5 | IE6 | CE1 | CE2 | CE3 |
|---|---|---|---|---|---|---|---|---|---|
| VORANOL ™ 4000LM polyol (g) | 7.3 | 7.3 | 7.3 | 6.0 | 6.0 | 6.0 | — | — | — |
| VORANOL ™ 8000LM polyol (g) | — | — | — | 2.0 | 2.0 | 2.0 | — | — | — |
| VORANOL ™ CP 6001 polyol (g) | 2.7 | 2.7 | 2.7 | 2.0 | 2.0 | 2.0 | — | — | — |
| VORANOL ™ 2000LM polyol (g) | — | — | — | — | — | — | 7.3 | 7.3 | 7.3 |
| VORANOL ™ 4701 polyol (g) | — | — | — | — | — | — | 2.7 | 2.7 | 2.7 |
| Desmodur CD-C MDI (g) | 2.8 | — | 1.9 | 2.7 | — | 1.8 | 3.5 | — | 2.3 |
| ISONATE ™ 50 OP Pure MDI (g) | — | 2.4 | 0.8 | — | 2.4 | 0.8 | — | 3.0 | 1.0 |
| Viscosity (Pa.s) | 15.7 | 6.4 | 12.5 | 14.9 | 9.1 | 12.5 | 34.3 | 12.2 | 16.1 |
| Phase separation | No | No | No | No | No | No | No | No | No |

TABLE 3
Formulations and test results of Inventive Examples 7-8
and Comparative Example 4

| | IE7 | IE8 | CE4 |
|---|---|---|---|
| VORANOL ™ 4000LM polyol (g) | 36.5 | 36.5 | 36.5 |
| VORANOL ™ 1447 polyol (g) | | | 13.5 |
| VORANOL ™ CP-3001 polyol (g) | 13.5 | | |
| VORANOL ™ CP 4610 polyol (g) | | 13.5 | |
| ISONATE ™ 50 OP Pure MDI (g) | 13.1 | 12.5 | 12.5 |
| Viscosity (Pa.s) | 14.4 | 10.6 | 12.5 |
| Phase separation | No | No | Yes |

TABLE 4
Formulations and test results of Inventive Examples
9-10 and Comparative Examples 5-6

| | IE9 | IE10 | CE5 | CE6 |
|---|---|---|---|---|
| VORANOL ™ 2000LM polyol (g) | | | 181.5 | 186.2 |
| VORANOL ™ 4701 polyol (g) | | | 82.9 | 80.1 |
| VORANOL ™ 4000LM polyol (g) | 195.6 | 196.2 | | |
| VORANOL ™ CP 6001 polyol (g) | 72.3 | 72.6 | | |
| Chlorinated paraffin (g) | 108.4 | 121.2 | 106.4 | 120.1 |
| BYK-W 980 wetting dispersant (g) | 2.4 | 3.1 | 2.3 | 3.0 |
| 800 mesh calcium carbonate (g) | 455.1 | 446.5 | 450.0 | 442.4 |
| ISONATE ™ 50 OP Pure MDI (g) | 51.6 | | 64.0 | |
| VORANATE ™ T-80 Type I TDI | | 35.7 | | 44.6 |
| S-150 solvent(g) | 110.9 | 121.2 | 109.2 | 120.1 |
| DABCO T-12 catalyst (g) | 0.9 | 1.0 | 0.9 | 1.0 |
| DMDEE catalyst (g) | 1.3 | 0.4 | 1.3 | 0.4 |
| BYK-066 N defoaming agent (g) | 1.5 | 2.1 | 1.5 | 2.0 |
| Viscosity (Pa.s) | 5.0 | 8.3 | 6.0 | 14.4 |
| Tear Strength (Newton/millimeter) | 22.0 | 17.9 | 18.0 | 15.3 |
| Phase separation | No | No | No | No |

IV. Results

IE1, IE4 and CE1 used equivalent amount of Desmodur CD-C MDI, but different polyol blends. IE2, IE5 and CE2 used equivalent amount of ISONATE™ 50 OP Pure MDI, but different polyol blends. IE 3, IE 6 and CE 3 used equivalent amount of the blend of Desmodur CD-C MDI and ISONATE™ 50 OP Pure MDI, but different polyol blends. The inventive examples using the polyol blend of the present invention in each group exhibit significantly lowered viscosities compared with the comparative examples in each group respectively.

CE4 uses the polyol blend comprising VORANOL™ 1447 polyol, which is a trifunctional polyether polyol end-capped with 71.2 wt %, based on the total weight of the trifunctional polyether polyol, of ethylene oxide. Undesired phase separation occurred in CE4 due to the high ethylene oxide content. In contrast, IE7 and IE8 using the polyol blend of the present invention do not have the phase separation issue.

IE9 and CE5 used equivalent amount of polyisocyanate and additives, but different polyol blends. IE10 and CE6 used equivalent amount of polyisocyanate and additives, but different polyol blends. IE9 and IE10 using the polyol blend of the present invention exhibit significantly lowered viscosities compared with CE5 and CE6.

1. A one-component type polyurethane prepolymer composition comprising a reaction product formed through a reaction between reactants comprising
(a) at least one polyisocyanate, and
(b) a polyol blend comprising
at least one bifunctional polyether polyol, wherein the bifunctional polyether polyol is a homopolymer of propylene oxide, homopolymer of butylene oxide, or copolymer of alkylene oxide, and has a number average molecular weight from 3000 g/mol to 9000 g/mol, and
at least one trifunctional polyether polyol, wherein the trifunctional polyether polyol is a copolymer of alkylene oxide and end-capped with 10 wt % to 28 wt %, by the total weight of the trifunctional polyether polyol, of ethylene oxide, and has a number average molecular weight from 5000 g/mol to 8000 g/mol,
wherein the bifunctional polyether polyol and the trifunctional polyether polyol are present in a parts by weight ratio from 4:1 to 2.5:1, and
wherein the polyisocyanate and the polyol blend are present in a parts by weight ratio of from 1:7 to 1:2.5.

2. The one-component type polyurethane prepolymer composition of claim 1, wherein the polyol blend comprises one bifunctional polyether polyol having a number average molecular weight from 3000 g/mol to 5000 g/mol and one trifunctional polyether polyol having a number average molecular weight from 5000 g/mol to 7000 g/mol.

3. The one-component type polyurethane prepolymer composition of claim 1, wherein the polyol blend comprises at least two bifunctional polyether polyol, wherein the first bifunctional polyether polyol has a number average molecular weight from 3000 g/mol to 5000 g/mol, wherein the second bifunctional polyether polyol has a number average molecular weight from 7000 g/mol to 9000 g/mol, wherein the first bifunctional polyether polyol and the second bifunctional polyether polyol are present in a parts by weight ratio of from 3:1 to 1:3.

4. The one-component type polyurethane prepolymer composition of claim 1, wherein the polyisocyanate is selected from a liquid carbodiimide modified MDI, an MDI-50, or a mixture thereof.

5. The one-component type polyurethane prepolymer composition of claim 1, further comprising, from 5 wt % to 13 wt %, based on the total weight of the one-component type polyurethane prepolymer composition, of an organic solvent.

6. The one-component type polyurethane prepolymer composition of claim 1, further comprising from 40 wt % to 60 wt %, based on the total weight of the one-component type polyurethane prepolymer composition, of a filler.

7. A waterproofing coating material comprising the one-component type polyurethane prepolymer composition of claim 1.
